(19) United States
(12) Patent Application Publication
(10) Pub. No.: US 2015/0070166 A1
(43) Pub. Date: Mar. 12, 2015

(54) SYSTEM AND METHOD FOR GUNSHOT DETECTION WITHIN A BUILDING

(71) Applicant: Elwha LLC, Bellevue, WA (US)

(72) Inventors: EDWARD S. BOYDEN, CHESTNUT HILL, MA (US); WILLIAM D. DUNCAN, KIRKLAND, WA (US); BRAN FERREN, BEVERLY HILLS, CA (US); RODERICK A. HYDE, REDMOND, WA (US); MURIEL Y. ISHIKAWA, LIVERMORE, CA (US); JORDIN T. KARE, SEATTLE, WA (US); STEPHEN L. MALASKA, REDMOND, WA (US); NATHAN P. MYHRVOLD, MEDINA, WA (US); DAVID B. TUCKERMAN, LAFAYETTE, CA (US); LOWELL L. WOOD, JR., BELLEVUE, WA (US)

(21) Appl. No.: 14/021,258

(22) Filed: Sep. 9, 2013

(51) Int. Cl. G08B 25/08; G08B 25/01

(52) U.S. Cl. CPC G08B 25/08; G08B 25/012
USPC 340/540

(57) ABSTRACT

A system for detecting a discharge of a firearm includes a detection component and an appropriation component. The detection component is configured to detect a discharge of a firearm within a building using one or more sensors communicatively coupled with a central server. The appropriation component configures one or more telephones within the building to gather and transmit audio data to the central server, in response to detecting the discharge of the firearm.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

None.

### RELATED APPLICATIONS

United States patent application No. To be assigned, entitled SYSTEM AND METHOD FOR GUNSHOT DETECTION WITHIN A BUILDING, naming EDWARD S. BOYDEN, WILLIAM D. DUNCAN, BRAN FERREN, RODERICK A. HYDE, MURIEL Y. ISHIKAWA, JORDIN T. KARE, STEPHEN L. MALASKA, NATHAN P. MYHRVOLD, DAVID B. TUCKERMAN, LOWELL L. WOOD, JR. as inventors, filed 9 Sep. 2013 with attorney docket no. 0307-008-002-000000, is related to the present application, and is herein incorporated by reference in its entirety.

United States patent application No. To be assigned, entitled SYSTEMS AND METHODS FOR MONITORING SOUND DURING AN IN-BUILDING EMERGENCY, naming EDWARD S. BOYDEN, JESSE R. CHEATHAM III, WILLIAM D. DUNCAN, BRAN FERREN, RODERICK A. HYDE, MURIEL Y. ISHIKAWA, JORDIN T. KARE, STEPHEN L. MALASKA, NATHAN P. MYHRVOLD, DAVID B. TUCKERMAN, LOWELL L. WOOD, JR. as inventors, filed 9 Sep. 2013 with attorney docket no. 0407-006-007-000000, is related to the present application, and is herein incorporated by reference in its entirety.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data SheetSheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### BRIEF DESCRIPTION OF THE FIGURES

FIG. 1 is a schematic block diagram of a system for detection and location of gunshots within a building.

FIG. 2 is a schematic of a floor plan of a building.

FIG. 3 is a schematic block diagram of a gunshot detection system.

FIG. 4 is a schematic block diagram of a telephone.

FIG. 5 is a diagram illustrating signatures of a discharge of a firearm.

FIG. 6 is a schematic flow chart diagram of a method for detecting a discharge of a firearm within a building.

FIG. 7 is a schematic flow chart diagram of another method for detecting a discharge of a firearm within a building.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Law enforcement or first responder personnel arriving upon a scene are often low on information regarding any events that have already occurred. or that are currently underway For example, in the cases of robberies, threats, or public shootings, it may not be clear whether or not any shots have been fired, if a hostage situation is underway, or the like. This lack of initial information often delays actions by those arriving at a scene because it is important to understand what has happened in order ensure personnel as well as bystander safety. However, in certain situations, quick action could lead to significant reduction of harm to potential victims at the scene.

One example of public threats that have begun to occur more frequently includes public shootings in a crowded location, such as a government building, school, or shopping center. These situations often result in a large number of injuries and deaths. Because time is of the essence in these situations, it is helpful for police officers or other first responders to have a clear and accurate understanding of the current situation as quickly as possible. In the case of public shootings, examples of details that may allow an officer to respond quickly and reduce potential harm may include whether a shot has been fired and how many, the location of any shots within a building, a likely location of the shooter when the shots occurred, the number of gunmen, or the like.

The present application discloses systems and methods for detecting the discharge of firearms within a building. In one embodiment, a system for detecting a discharge of a firearm includes a detection component and an appropriation component. The detection component is configured to detect a discharge of a firearm within a building using one or more sensors communicatively coupled with a central server. The appropriation component is configured to configure one or more telephones within the building to gather and transmit audio data to the central server, in response to detecting the discharge of the firearm.

As used herein the terms “gunshots” and “discharge” are given to mean the discharge or firing of a gun or firearm within a building. Generally, the terms gunshot and discharge as used herein are interchangeable, unless otherwise explicitly indicated.

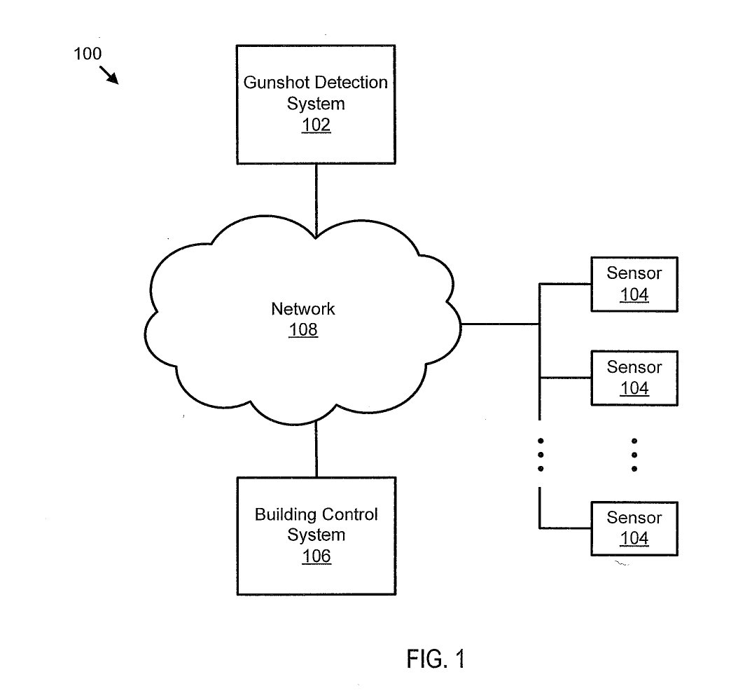

FIG. 1 illustrates an example system 100 for detection and location of gunshots within one or more buildings. The system 100 includes a gunshot detection system 102, a plurality of sensors 104, and a building control system 106 that communicate over a network 108.

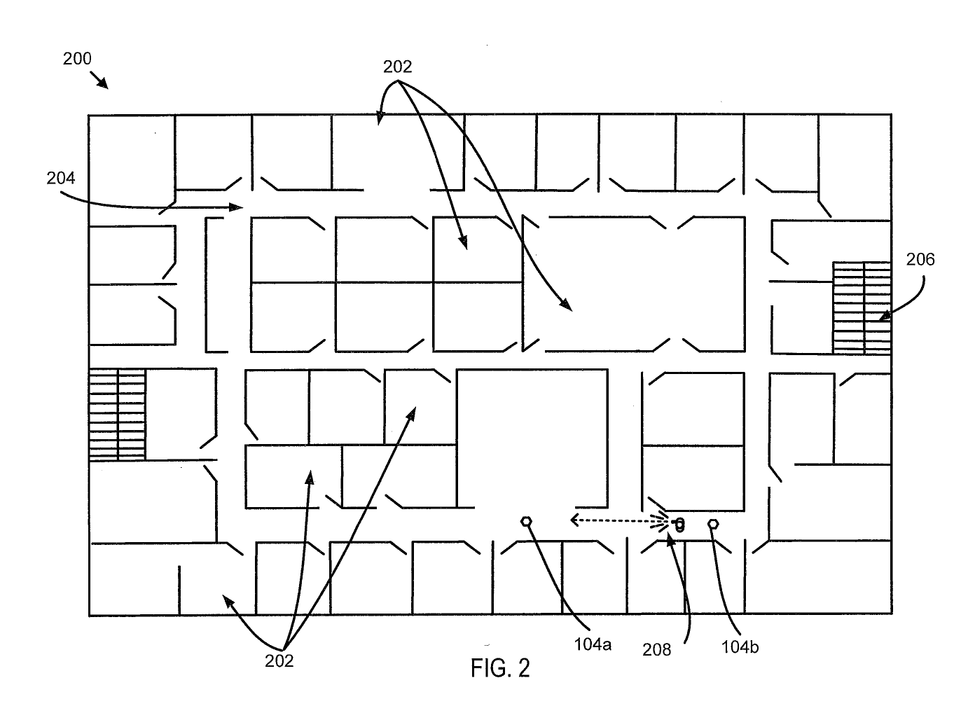

The sensors 104 may include devices which may be used to detect a gunshot. Example sensors may include, but are not limited to, a microphone, an optical sensor, a chemical detector, an infrared sensor, a vibration sensor, or the like. The sensors 104 may be located throughout a building or another venue. FIG. 2 illustrates a floor plan 200 of a building where the sensors 104 may be deployed. The floor plan 200 includes a plurality of rooms 202, hallways 204, and stairwells 206. A discharge 208 of a firearm is illustrated in one of the hallways 204. Sensors 104a and 104b are depicted in a hallway 204. Only two sensors 104a and 104b are shown for simplicity and clarity of discussion.

In one embodiment, the sensors 104 include sensors 104 within many rooms, hallways, stairwells, and other locations of a building. The sensors 104 may be distributed throughout the building in a manner to provide coverage for detection of gunshots throughout the building. For example, if the sensors include microphones, substantially every location within the building may be within detection range of at least one microphone. Similarly, if the sensors include optical detectors, substantially every location within the building may be within detection range of at least one optical sensor. In one embodiment, at least one sensor may be located within every room 202, hallway 204, and/or stairwell 206 of the building. The sensors 104 may be mounted on walls, ceilings, or furniture within the building. For example, one or more sensors may be located within a smoke detector, a motion detector, or other sensors or device generally already included in large publicly accessible buildings. In one embodiment, one or more sensors 104 used to detect the gunshot may be located within telephones or other communication devices within the building. For example, a microphone of a telephone may be used to detect gunshots.

The gunshot detection system 102 detects a gunshot based on sensor data from one or more sensors 104. In one embodiment, the gunshot detection system 102 receives sensor data from the one or more sensors 104. For example, the sensors 104 may provide sensor data to the gunshot detection system 102, which can then evaluate the sensor data to determine whether a gunshot has occurred. In another embodiment, the gunshot detection system 102 receives an indication that a gunshot was detected from the sensors 104 or devices hosting the sensors 104 and determines that a gunshot has occurred based on the indication.

In one embodiment, the gunshot detection system 102 includes a central server located remotely from the one or more sensors 104. For example, the gunshot detection system 102 may include a private branch exchange (PBX) within a private network of the building. As another example, the gunshot detection system 102 may include a central server on a public network. In one embodiment, the gunshot detection system 102 detects gunshots within a single building or within a plurality of different buildings. The gunshot detection system 102 will be discussed in greater detail below.

The building control system 106 may include systems for controlling operation of the building. For example, the building control system 106 may be configured to control lights, locks, intercom systems, or the like within the building. In one embodiment, the gunshot detection system 102 may be configured to interface with the building control system 106 to control operation of the building and or obtain additional information about an incident in the building.

The network 108 may include one or more wired or wireless networks. In one embodiment, the network 108 may include a wired or wireless phone system used for telephone communications. For example, an existing telephone system may be capable of communicating with a phone in each room 202 of the floor plan of FIG. 2. The existing telephone system may be used to provide communication between the sensors 104, gunshot detection system 102, and/or the building control system 106. In other embodiments, the network 108 includes any type of communications network including a local area network (LAN), wide area network (WAN), a portion of a cellular network, the Internet, or any other wired or wireless communication system. In one embodiment, the network 108 includes both wired and wireless nodes. For example, the sensors 104 may be configured to transmit data to the gunshot detection system 102 via a wireless node.

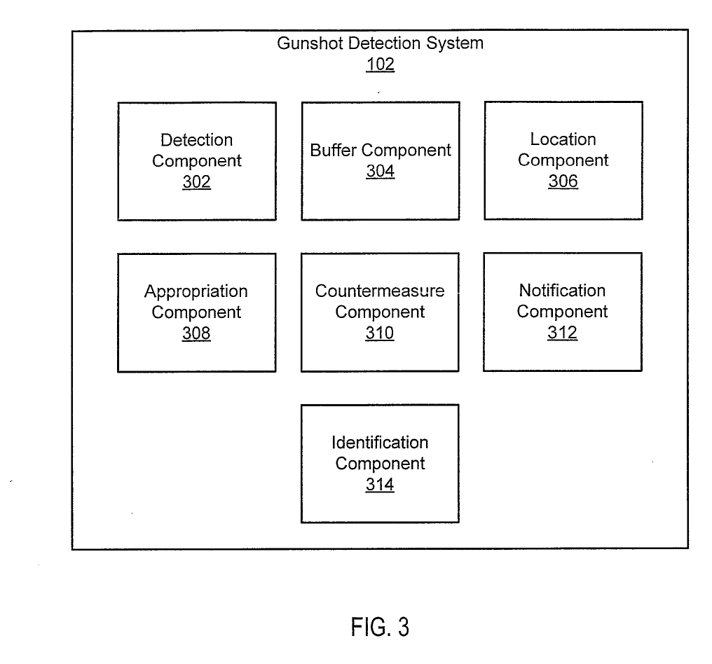

FIG. 3 is a schematic block diagram illustrating example components of a gunshot detection system 102. The gunshot detection system 102 is shown including a detection component 302, a buffer component 304, a location component 306, an appropriation component 308, a countermeasure component 310, a notification component 312, an identification component 314, a processor 316, and an interface 318. The components 302-314 are shown by way of example only and fewer or additional components may be included in some embodiments. In fact, varying embodiments may include only one or any combination of the components 302-314 without limitation. The components may be implemented, in various embodiments, using any suitable combination of hardware, software, and/or firmware.

The detection component 302 is configured to detect a discharge of a firearm within a building using one or more sensors 104. The one or more sensors 104 may be communicatively coupled with a central server. Although the detection component 302 is depicted as located in gunshot detection system 102, the detection component 302 may also be located elsewhere, such as in a sensor 104 or a device that includes one or more sensors 104. In one embodiment, a detection component 302 in the gunshot detection system 102 detects a discharge based on direct analysis of sensor data.

In another embodiment, the detection component 302 detects a discharge based on an indication received from one or more sensors 104 or devices which have analyzed the sensor data. For example, a telephone may evaluate audio data obtained by a microphone to detect a discharge of a firearm. The telephone may send an indication reporting the occurrence of the discharge to the detection component 302 of the gunshot locator system in response to locally detecting occurrence of the discharge. For example, two or more telephones may be configured to independently process audio data obtained using corresponding microphones to identify an acoustic signature of a discharge. The detection component 302 may receive, in addition to the indication, audio data from the telephones corresponding to the discharge and process the audio data to confirm the occurrence of the discharge. Detection of a discharge at the sensors 104 (e.g., telephones) as well as the gunshot detection system 102 may provide redundancy in gunshot detection. In one embodiment, the detection component 302 may detect a discharge of a firearm based on audio data. For example, the detection component 302 may detect the discharge based on audio data obtained by one or more microphones of one or more telephones in a building. In one embodiment, the detection component 302 and/or one or more sensors 104 (such as a telephone) may include a digital signal processor for processing the audio data. In addition to detection based on audio data, the detection component 302 of the gunshot detection system 102 may confirm the occurrence of the discharge based on any type of sensor data.

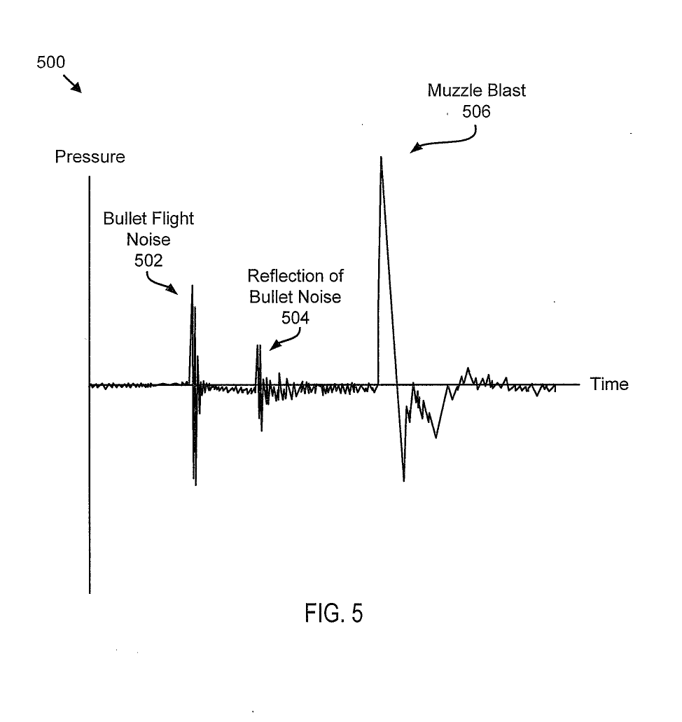

The detection component 302 may detect the discharge by detecting one or more acoustic signatures of a firearm discharge. FIG. 5 illustrates a graph 500 of a sound recording of a firearm discharge. The graph 500 illustrates change in pressure over time as detected by a microphone or another sound wave sensor. The graph 500 shows various signatures which may be detected by the detection component 302 to determine that a firearm discharge has occurred. The graph 500 includes a first signature 502 corresponding to bullet flight noise, a second signature 504 corresponding to reflection of the bullet flight noise, and a third signature 506 that corresponds to a muzzle blast. Some embodiments may include multiple reflections of the bullet flight noise and/or muzzle blast. For example, in an interior area of a building, walls, floors, ceiling, furniture, or other objects may cause an increased number of reflections.

In one embodiment, the detection component 302 detects one or more of the signatures 502, 504, 506 to determine that a firearm discharge has occurred. For example, the detection component 302 may detect a high intensity sound with a fast rise time to detect the third signature 506 corresponding to the muzzle blast. Similarly, the detection component 302 may determine that a gunshot has occurred based on the presence of two or more of the signatures 502, 504 and 506.

The graph 500 is given by way of example only. For example, the graph 500 illustrates how sound from a gun discharged in a direction of a microphone would be detected because sound from the bullet, which is traveling faster than the speed of sound, may reach the sensor 104 before the sound from a muzzle blast. The graph 500 illustrates sensor data corresponding to the discharge 208 illustrated in FIG. 2 at sensor 104a, wherein the discharge 208 was in the direction of sensor 104a. Considerable variation is possible based on a position of the sensor, the type of firearm or ammunition used, as well as the environment in which the firearm was discharged. In some situations, a plurality of reflections (such as second signature 504) may be present depending on an environment where the firearm is fired. For example, smaller rooms may include a greater number of reflections and/or the reflections may be closer together. Similarly, the spacing and order between the signatures 502, 504, 506 may also vary. In one embodiment, for example, the third signature 506 corresponding to the muzzle blast may occur prior to signatures 502, 504 corresponding to bullet flight noise and reflections depending on whether the firearm is pointing toward or away from a sensor 104 during the discharge. For example, sensor 104b may detect the muzzle blast from the discharge 208 of FIG. 2 before the bullet flight noise. In another embodiment, an audio signature corresponding to the bullet impacting an object may be present.

In one embodiment, the audio data is filtered for privacy or accuracy of detection. In one embodiment, the detection component 302 detects a discharge based on detecting an acoustic signature in a low frequency audio feed from the microphone. For example, the audio in higher frequencies may be filtered out of the audio feed by the sensor 104 and/or the detection component 302. In one embodiment, the detection component 302 detects an acoustic signature based on a non-vocal frequency feed from the microphone. For example, vocal frequencies may be filtered out of the audio feed by the sensor and/or the detection component 302 prior to analysis. In one embodiment, filtering out vocal frequencies may allow for privacy within the building even while detection of gunshots is enabled.

The detection component 302 may detect the discharge by detecting a muzzle flash. For example, during a discharge, firearms often create a bright flash at the end of the muzzle. In one embodiment, an optical sensor is used to detect the muzzle flash and thereby detect the occurrence of the discharge. The detection component 302 may detect the muzzle flash based on one or more of a time signature and a spectral signature of the muzzle flash. For example, the detection component 302 may detect a flash with a specific light frequency content, time length, and/or brightness. The muzzle flash may be detected based on a line of sight detection and/or may also detect the flash based on a reflection of the muzzle flash. For example, the muzzle flash may be reflected off of walls, windows, and/or furniture. Thus, a discharge with the gun pointing away from an optical sensor may still be detected.

In one embodiment, a simple optical sensor comprising one or more photodiodes and/or a digital signal processor may be used. For example, while a camera may be used to detect the muzzle flash, more simple optical sensors incapable of capturing images may be used. Because a complete camera system may not be needed the optical sensor may be simple and cheap, reducing costs of the system. In one embodiment, one or more photodiodes are included in a smoke detector to detect muzzle flashes in various directions. In one embodiment, detection of a muzzle flash may be combined with detection of an audio signature to provide reduced false positive or false negative gunshot detections.

The detection component 302 may detect the discharge by detecting a chemical fume corresponding to the discharge. For example, the combustion of gun powder and other events that occur during the discharge of a firearm result in chemical fumes that are normally not present in some public buildings, venues, or other locations. Chemical detectors located within the building may detect these fumes and notify the detection component 302. The detection component 302 may determine that a gunshot has occurred based on the detected fumes.

The detection component 302 may detect the discharge based on any other type of sensor data and/or sensors 104. For example, an infrared sensor may be used to detect a heat signature of a firearm before, during, and/or after a firearm discharge. As an additional example, a pressure sensor may detect the occurrence of a high pressure sound wave corresponding to the discharge. Any other type of sensor may be used in various embodiments.

In one embodiment, the detection component 302 detects the discharge based on calibration data for the one or more sensors. In one embodiment, the detection component 302 uses the calibration data to determine how the sensor data corresponding to a specific sensor should be interpreted. For example, if a first microphone is calibrated to be more sensitive than a second microphone, the detection component 302 can determine whether a gunshot has occurred based on normalized values for the microphones. In one embodiment, the calibration data includes pre-calibration data for a specific building. For example, the pre-calibration data may include data derived from pre-calibration gunshots or models of how the building would respond to gunshots at different locations in the building.

In one embodiment, the detection component 302 may detect the occurrence of a gunshot based on data from a plurality of sensors 104. For example, the detection component 302 may allow for a reduced threshold of detection if a larger number of sensors 104 meet a lower threshold of confidence that a discharge has occurred. Thus detection of a discharge may be possible even if none of the sensors 104 have detected a discharge meeting a higher threshold of confidence on their own.

In addition to detecting the occurrence of the discharge, the detection component 302 may determine additional information regarding an incident. For example, the detection component may determine how many shots were fired. As another example, the detection component 302 may determine a confidence level indicating how confident the gunshot detection system 102 is that a gunshot has occurred.

The buffer component 304 buffers sensor data for a predefined time period. For example, the buffer component 304 may store sensor data received from the one or more sensors 104 in a buffer. The sensor data within the buffer may be accessed to evaluate the sensor data in real-time or at a later time during the predefined period. In one embodiment, the buffer component 304 is configured to delete data in the buffer after the predefined period. For example, data older than a predefined number of seconds, minutes or hours may be deleted from the buffer if no discharge is detected. In one embodiment, deletion of the buffered data reduces privacy concerns or the like. The buffer component 304 may store a time stamp in the buffer corresponding to when the sensor data was collected.

Depending on the embodiment, the buffer component 304 may be located in the gunshot detection system 102, at the sensor 104, or elsewhere. For example, if the buffer component 304 is located in the gunshot detection system 102, the sensor data for a plurality of sensors 104 may be stored in the same buffer. The data in the buffer may be available to the detection component 302 and/or other components of the gunshot detection system 102. Storage of the sensor data and/or real-time transmission of sensor data may allow the detection component 302 to detect gunshots in real-time. In one embodiment, the buffer component 304 buffers data for all of the sensors 104 so that the gunshot detection system 102 can evaluate all data, even data corresponding to sensors that did not initially detect a firearm discharge.

In one embodiment, a buffer component 304 may be located remotely from the gunshot detection system 102 and/or a central server. For example, a buffer component 304 may be located at each sensor or at each device hosting one or more sensors. Buffering the data locally to the sensors 104 or host devices may allow for secure detection while also allowing for evaluation of data as needed after a gunshot has occurred. In one embodiment, the buffer component 304 is configured to transmit the sensor data in a buffer to a central server or gunshot detection system 102 in response to the detection component 302 detecting the discharge of the firearm. For example, a detection component 302 local to a sensor 104 may detect a discharge and then send the data in the buffer to the gunshot detection system 102 for analysis. In a further embodiment, a buffer component 304 local to a sensor 104 transmits data in the buffer to the gunshot detection system 102 in response to a request from the gunshot detection system 102. For example, sensor data from a sensor 104 that has not detected a discharge may be transmitted to the gunshot detection system 102 in response to the request. The request may include an indication that a discharge has been detected. In one embodiment, sensor data buffered locally to a sensor 104 is transmitted and stored in a buffer at a central server that includes the gunshot detection system 102.

The location component 306 determines a location at which the firearm was discharged within the building. In one embodiment, the location component 306 determines the location based on sensor data from the one or more sensors 104 and/or a location of each sensor 104. For example, the location component 306 may determine the location based on sensor data from sensors 104 comprising any combination of microphones, optical sensors, chemical detectors, infrared sensors, vibration sensors, or the like.

The location component 306 may be able to determine a location of the discharge based on the sensor data from a single sensor 104. In one embodiment, the location component 306 may determine a distance from a microphone based on the difference in time between receiving a signature corresponding to bullet flight noise (e.g., first signature 502) and a signature corresponding to a muzzle blast (e.g., third signature 506). For example, the location component 306 may determine that the discharge occurred closer to the microphone when the bullet flight noise and muzzle blast are separated by a smaller time interval. Similarly, a loudness of audio, a brightness of a muzzle flash, and/or other details may be used to determine the proximity of a discharge to a specific sensor 104. In one embodiment, the detection component 306 may determine the location of the discharge based on spectral content of audio corresponding to the muzzle blast. For example, a discharge that has occurred at a further distance may have attenuated high frequency content because low frequency sounds tend to travel further and/or through and around obstacles better than high frequency sounds.

The location component 306 may determine a location of a discharge based on differences in how the discharge is detected at different locations. For example, microphones at different locations may have different sound signatures corresponding to the same discharge. In one embodiment, an order in which sound signatures are detected and/or the spectral content of a sound signature indicates proximity of the discharge to a sensor. The location component 306 may determine a location of the discharge based on these relative differences.

In one embodiment, the location component 306 determines a location of the discharge based on relative timing between sensor data of different sensors 104. For example, if a signature of a muzzle blast (e.g., third signature 506 of FIG. 5) is received at a first microphone before a second microphone, the location component 306 may determine that the discharge occurred closer to the first microphone. For example, since the discharge 208 of FIG. 2 is closer to the sensor 104b than the sensor 104a, the sensor 104b may detect the discharge earlier than the sensor 104a. The location component 306 may determine the location based on when sound corresponding to the discharge is received at microphones of two or more telephones. Similarly, the detection of a pressure wave, a chemical fume, or a muzzle flash, or another detection, at a first location before detection at a second location may indicate that the discharge occurred closer to the first location than the second location. For example, the detection of a muzzle flash (direct or reflected) from an optical sensor may, given the near-instantaneous propagation speed of light compared to intra-building distances, be used to determine a time-stamp for the firearm discharge. Then the times at which sound is detected at one or more microphones can be compared to the discharge time-stamp, and used to determine sound propagation distances from the firearm to the microphones. This information, in conjunction with building data on the building's sound propagation characteristics, can be used in determining the location of the firearm within the building.

Furthermore, the difference in time between when a sound wave, or other sensor signature, is detected at different sensors 104 combined with a distance between the sensors may be used to determine a region where the discharge occurred. For example, using triangulation and other techniques the location of the discharge may be estimated based on a propagation speed of sound. In one embodiment, the distances between the sensors 104 are based on a floor plan of the building. For example, a sound wave may travel an indirect route to a sensor due to walls, doorways, or the like, as illustrated in FIG. 2.

In one embodiment, the location component 306 may determine a location of the discharge based on amplitude, loudness, and/or intensity of the discharge detected at multiple sensors. For example, if a sound of a muzzle blast is louder at a first microphone than at a second microphone, the location component 306 may determine that the discharge occurred more closely to the first microphone. Similarly, if a muzzle flash appears brighter to a first optical sensor than a second optical sensor, the location component 306 may determine that the discharge occurred more closely to the first optical sensor. However, in some situations, it may be that the direction of the discharge causes the intensity at a more distant sensor 104 to be greater than at a more proximal sensor 104.

In one embodiment, the location component 306 may determine the location of the discharge based on pre-calibration data specific to the floor plan 200, building, and/or the one or more sensors 104. For example, the pre-calibration data may include calibration data of the sensitivity or other operating characteristics specific to a single sensor 104. In one embodiment, the calibration data may indicate a microphone sensitivity level, or the like, which may allow the location component 306 to normalize sensor data in order to accurately calculate differences between detection at different sensors 104. The microphone sensitivity level may be determined based on data provided by a manufacturer, as a result of pre-calibration gunshots or pre-calibration testing, and/or sensitivity levels determined by a telephone. In one embodiment, the microphone sensitivity level may be stored or determined at a sensor. In another embodiment, the microphone sensitivity level may be stored at and/or retrieved from the gunshot detection system 102 or other central server.

The pre-calibration data, in one embodiment, comprises data determined based on a computational model of a building. For example, three-dimensional models of buildings are often created for a large building and may be used to simulate how sound waves would move through the building. In one embodiment, the pre-calibration data includes simulated responses of sensors to gunshots at a plurality of locations within the building. The location component 306 may compare the actual response detected during a gunshot to the simulated responses in order to determine the location. For example, after a discharge has been detected the location component 306 may compare the actual response of the sensors 104 to the discharge to a plurality of simulated responses. The location component 306 may determine that the location of a simulated discharge that best matches the actual discharge is the location of the detected discharge.

The pre-calibration data may include data determined based on pre-calibration gunshots. For example, one or more pre-calibration gunshots may be performed after a location system, including sensors 104, has been installed in a building. The pre-calibration gunshots may include a gunshot including a discharge of a bullet, a gunshot comprising a discharge of a blank, and/or a gunshot comprising a sound generator mimicking a gunshot's signature in the building. The response of the sensors to the pre-calibration gunshots may be recorded. In one embodiment, during operation of the gunshot detection system 102, actual sensor responses to a firearm discharge may be compared to the pre-calibration data to determine where the discharge occurred.

The location component 306 may determine a specific location in the building where a discharge of a firearm occurred. For example, the location component 306 may determine one or more of a room, a floor, a stairwell, a hallway, or another location in the building where the discharge occurred. As another example, the location component 306 may determine a specific location within a room, a hallway, or another location within a building where the discharge occurred. In one embodiment, the location component 306 determines three dimensional coordinates in feet and/or inches where the discharge occurred. The location component 306 may determine a plurality of locations where the discharge occurred. For example, the location component 306 may determine two or more rooms, hallways, or other regions in a building where the discharge may have occurred.

In one embodiment, the location component 306 determines a confidence level for one or more locations where the discharge may have occurred. For example, if the location component 306 determines that a discharge may have occurred within a specific room of the building, the location component 306 may determine a confidence level for the room. If a location component 306 determines that a discharge has likely occurred within a plurality of rooms in the building, the location component 306 determines a confidence level for each of the plurality of rooms. In one embodiment, the location component 306 may determine where the discharge did not occur. For example, the location component 306 may determine where the discharge occurred by determining areas of the building in which the discharge likely did not occur.

As the number of sensors 104 that have information about the discharge increases, the location determination may become more accurate. For example, the location component 306 may be able to calculate the location separately based on data from each sensor or combination of sensors to come up with a more precise region or location for the discharge.

The location component 306 may determine a direction in which the firearm was discharged. For example, the location component 306 may determine a horizontal and/or vertical direction in which the firearm was discharged based on the sensor data. In one embodiment, the direction that the firearm was pointing during the discharge may be determined based on an acoustic signature of the discharge. For example, returning to FIG. 5, the order of when the bullet flight noise (first acoustic signature 502) and the muzzle blast (third acoustic signature 506) is received at a microphone may indicate whether the firearm was pointing toward or away from the microphone when the bullet moves faster than the speed of sound. For example, if the bullet flight noise is received before the muzzle blast, the location component 306 may determine that the firearm is at least partially pointing toward the microphone. On the other hand, if the muzzle blast noise is received before the bullet flight noise, the location component 306 may determine that the firearm is at least partially pointing away from the microphone. In one embodiment, the discharge 208 illustrated in FIG. 2 may result in the muzzle blast noise being received at sensor 104b before the bullet flight noise and at sensor 104a after the bullet flight noise. In one embodiment, the location component 306 may determine the direction based on one or more of the timing of sensor signatures received at different sensors, the relative loudness of sensor signatures (such as of bullet flight noise), or the like.

The appropriation component 308 configures one or more telephones within the building to gather and transmit audio data to a central server (such as a central server comprising the gunshot detection system 102). In one embodiment, the audio data may allow security personnel, law enforcement, or other persons or organizations to monitor what is happening following a discharge in real-time or at a later on. The audio data may include sounds generated by one or more of the intruders, e.g., conversations, sounds indicating their location or movement, sounds due to loading or reloading of weapons, or the like. The audio data may similarly include sounds generated by building occupants, indicating their emotional state, injuries, locations, or the like. Because telephones are often placed at multiple locations throughout a building, the telephones may provide significant and useful intelligence so that police or other responders can assess a situation and take possible action to deter or end an attack or another event.

In one embodiment, the appropriation component 308 configures all telephones within a building and connected to a telephone system to gather and transmit the audio data. In one embodiment, the appropriation component 308 may configure telephones to gather and transmit audio data which were not used to detect the discharge. For example, some phones in private locations (such as offices) may not be used for monitoring sounds to detect a gunshot. In one embodiment, telephones in public locations of the building are used to detect the discharge and telephones in both private and public locations are used to gather and transmit audio data to monitor an event or attack that is underway in the building.

In one embodiment, the appropriation component 308 may only configure telephones that are not currently in use (such as one engaged in a telephone call) to gather and transmit the data. Similarly, the appropriation component 308 may only configure telephones not occupied by an approved occupant to gather and transmit the audio data. For example, a phone located in an office may be configured to detect whether an authorized user (such as an employee who works in that office) is present and may not appropriate the phone (configure the phone to gather and transmit data) if the authorized user is present.

In one embodiment, the appropriation component 308 configures the telephones to gather and transmit the data to the central server in response to the detection component 302 detecting a firearm discharge. For example, the appropriation component 308 may configure the telephones to gather and transmit the audio data automatically in response to the detection component 302 detecting the discharge. In one embodiment, the appropriation component 308 configures the telephones to gather and transmit the audio data in response to a request from security personnel. For example, a building manager, law enforcement officer, or the like may send an electronic message to the gunshot detection system 102 to trigger the gathering and transmitting of audio data.

In addition to the audio data, the appropriation component 308 may also configure the telephones to transmit a time stamp, location stamp, and/or microphone calibration data. The time stamp may provide an accurate time regarding when the audio information was detected so that locations of sounds or occurrences within the building can be determined. The location stamp may indicate a location of the telephone within the building. For example, the location stamp may be helpful for wireless telephones or sensors that may be moved around. In one embodiment, the location of a telephone or another sensor may be retrieved from a database that stores the location of the sensors 104. The calibration data may indicate a sensitivity of the microphone.

In one embodiment, the appropriation component 308 configures the telephones to inhibit some uses of the telephone, in response to detection of the discharge. For example, a telephone may no longer be used to place a phone call, may or may not provide an indication that the phone is in use, or the like after it has been configured to gather and transmit the audio data. This may allow the system to use as many phones as possible to monitor the situation. Similarly, an existing call or new call may be prevented to prevent a user from using a telephone and being recorded.

The appropriation component 308 may configure the telephones to gather and transmit audio data by triggering a voice communication session with the telephones. For example, the telephones may gather and transmit audio data in manner similar to a normal phone call. In one embodiment, a law enforcement officer, a negotiator, or another individual could speak to occupants of the building, including an attacker, via the telephones. In one embodiment, the voice communication session may be initiated by initiating a phone call to the telephones.

The appropriation component 308 may configure the telephones to gather and transmit audio data for only a limited time period. For example, the telephones may be configured to stop gathering and transmitting the audio data after a defined time interval. In one embodiment, the telephones may gather and transmit audio data until an authorized individual initiates release of the appropriation. For example, the appropriation component may reconfigure the one or more telephones to stop gathering the audio data after a request from a building manager, law enforcement or other authorized personnel is received. In one embodiment, a telephone of the one or more telephones may be configured to stop gathering and transmitting audio data to the central server in response to a person placing a phone call.

The countermeasure component 310 may be configured to implement one or more countermeasures to reduce the harm or damage a criminal, attacker, or perpetrator can cause to individuals in the building. In one embodiment, the countermeasure component 310 may be configured to play audio, control lighting systems, control locks, or control other systems in a building that may reduce any damage or harm an attacker can cause. For example, buildings often have a variety of control systems that can control various operations within a building. In one embodiment, these control systems may be accessed to make it more difficult for a shooter to harm as many innocent individuals in the building. The countermeasure component 310 may implement automatic countermeasures and/or may be controllable by an authorized individual locally or remotely from the building in response to detection of the discharge.

In one embodiment, the countermeasure component 310 plays audio in the building. For example, the countermeasure component 310 may play audio in the building using one or more appropriated telephones (telephones which have been configured to gather and transmit audio data by the appropriation component 308), an intercom system, or another speaker or system of speakers in the building. The audio may include an audible message to occupants of the building. For example, the audible message may provide information about an emergency that has happened or is happening in the building. The audible message may provide instructions regarding what individuals should do. For example, information regarding a safety status of the building or an area of the building may be played and/or an exit route to use to exit the building may be played. Individuals in the building may be able to listen to the message and thereby know how get out of the building to escape danger or receive instruction to stay put in order to stay safe. In one embodiment, the audible message may indicate a location of the attacker and/or gunshots in the building so that occupants know what areas to avoid. In one embodiment, different messages may be played in different parts of the building so that an attacker is not aware of what individuals in the building are being told.

Similarly, audio meant to be heard by an attacker may also be played. For example, the attacker may be told information about law enforcement officers being on their way or arriving at the scene or a voice of a negotiator may be played. The audio may include audio to hopefully cause the attacker to slow down, become disoriented, or be deterred from shooting or looking for additional victims. For example, loud audio to disorient the attacker, audio to imitate a presence of law enforcement personnel, or other audio may be played that may cause the attacker to believe that law enforcement has arrived or is present in the building. In one embodiment, the audio includes the sound of an officer's voice, a sound of a siren, and/or a sound of a gunshot. As discussed above, audio meant for the attacker may be played in a region of the building targeting the attacker. For example, individuals in other areas of the building may not be subjected to the same audio as the attacker.

In one embodiment, the countermeasure component 310 controls lights and/or a lighting system in the building. In one embodiment, the countermeasure component 310 powers off one or more lights in the building. For example, lights where the attacker is located may be powered off to reduce the attacker's vision. In one embodiment, the countermeasure component 310 may pulse one or more lights, increase an intensity of lights, or control a lighting color to disorient or otherwise slow down the attacker. In one embodiment, the color of the lights may be adjusted to cause a high color shear effect that makes it difficult for an attacker to see or makes it uncomfortable for the attacker to look around. Similarly, the lights may be controlled to indicate a safe exit route out of the building to one or more occupants. As mentioned above, lights near to the attacker may be controlled independently or in a different manner from lights in portions of the building where the attacker is not located.

In one embodiment, the countermeasure component 310 controls one or more electronic locks in the building. For example, the countermeasure component 310 may cause one or more doors to shut and/or lock in response to the detection component 302 detecting the discharge of the firearm. In one embodiment, the doors that are shut and/or locked may be based on a detected location of the gunshot. For example, doors may be shut and locked to confine the attacker to a specific region of a building. In one embodiment, the countermeasure component 310 and/or a human operator may determine doors to lock and/or unlock to reduce the amount of harm that can come to individuals within the building.

The countermeasure component 310 may be configured to control other systems within a building. For example, the countermeasure component 310 may be configured to trigger a sprinkler system within the building in response to detecting the gunshot and/or a request from an authorized individual.

The notification component 312 is configured to provide a notification to one or more individuals that an attack or another emergency has occurred. In one embodiment, the notification component 312 triggers an alarm within the building. The notification component 312 may notify security personnel, a security company, and/or law enforcement. For example, the notification component 312 may initiate a phone call, send a message, or provide a notification of the detected discharge in any other manner. In one embodiment, a message or other notification includes information regarding a time of a detected gunshot, a location in the building, or any other details detected or determined by the gunshot detection system 102.

In one embodiment, the notification component 312 may provide messages to one or more employees or other individuals that normally work or are present in the building. For example, the notification component 312 may send a message that an emergency has occurred in the building via text message, email, phone call, or other message. In one embodiment, the notification component 312 may provide the messages to one or more mobile devices. The messages may provide information about the attack and/or instructions on how to stay safe during the attack. For example, any of the information discussed above in relation to audible messages played in the building may also be provided by the notification component 312. Thus, individuals who are away from the building or more likely to get messages via phone or email may be informed to avoid the building or a location in the building. In one embodiment, the notification component 312 may cause messages to be played or displayed at entrances to the building in order to notify individuals of the danger.

The identification component 314 identifies a type of firearm based on sensor data from the one or more sensors 104. In one embodiment, the identification component 314 may identify the firearm as a handgun, a rifle, shotgun, or another type of gun. For example, guns with different barrel lengths may have different sound signatures corresponding to the time it takes between pulling a trigger and the bullet and muzzle blast coming out the end of the gun. Similarly, the identification component 314 may be able to provide specific makes and/or models of guns used in the discharge.

In one embodiment, the firearm type may be determined based on the frequency content or another acoustic signature of the gun. For example, the caliber of the gun as well as the amount of gunpowder or force of the exiting projectiles may be determined based on an audio frequency content and/or loudness of different frequencies in relation to each other. For example, discharges with greater low frequency content may correspond to larger guns. In one embodiment the frequency content of a bullet flight noise signature may provide information regarding a size of the projectile (and/or a number of projectiles) as well as a speed. Similarly, the frequency content of a muzzle blast signature may provide information about the type of gun and/or ammunition.

The frequency content of a detected muzzle flash may provide information about the type of gun powder, the primer, the size of the gun, or other information regarding the rounds and/or the gun. In one embodiment, the types of projectiles used (such as shot in shot guns, hollow tip, or armor piercing projectiles) or the types of rounds may also be determined based on audio and/or optical data. The types of projectiles and/or rounds may also have different flight noise signatures that help identify the type of gun used. In one embodiment, the firearm identification component 314 may determine the firearm type based on a chemical fume detected by a chemical sensor. For example, different types of guns and/or types of ammunition may produce different types and amounts of fumes. This information may be used to determine a more specific type of gun and/or ammunition used in the discharge. In one embodiment, the identification component 314 may initially determine a type of gun as a hand gun or rifle and/or an estimated caliber to provide quick information regarding the discharge. More detailed and time-consuming analysis may follow to determine more specific details about the type of gun, if needed. In some embodiments, the identification component 314 may determine the discharge of multiple guns, differentiating them by disparate acoustic signatures and/or locations. In some embodiments, the identification component 314 may count the number of shots fired by each gun.

The processor 316 may include a general purpose and/or specialized processor. For example, the gunshot detection system 102 may include a server with one or more central processing units (CPUs) for processing requests, storing, data and performing computations. In one embodiment, the processor 316 may include a specialized processor such as a digital signal processor for processing data from the one or more sensors 104. In one embodiment, the processor 316 may be configured to execute code corresponding to the other components 302-314 and 318. One of skill in the art will recognize that considerable variation is possible in relation to the number and types of processors that may be used.

The interface 318 includes one or more display or communication interfaces. In one embodiment, the interface 318 includes a display screen for displaying notifications regarding the occurrence of a discharge or other information regarding the discharge of a firearm. For example, the display screen may include a computer monitor that displays a map of a floor plan (such as floor plan 200 of FIG. 2) and may indicate a location of a discharge in the floor plan on the display screen. In one embodiment, the display may include a control interface for controlling operation of the gunshot detection system 102. In one embodiment, the control interface may control settings corresponding to one or more of the detection component 302, the buffer component 304, the location component 306, the appropriation component 308, the countermeasure component 310, the notification component 312, and the identification component 314.

In one embodiment, the interface 318 includes a communication interface for communicating data between the gunshot detection system 102 and the sensors 104, building control system 106, or other device or network. For example, the interface 318 may allow the notification component 312 to communicate details regarding a discharge or an attack to another machine or location. In one embodiment, the interface 318 is configured to transmit data regarding a discharge to a computing device where the information may be displayed.

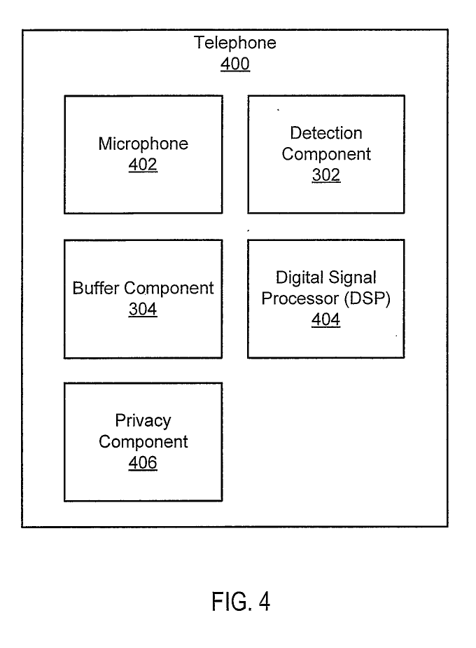

FIG. 4 is a schematic block diagram of a telephone 400, according to one embodiment. The telephone 400 includes a microphone 402, a detection component 302, a buffer component 304, a digital signal processor 404, and a privacy component 406. In one embodiment, the telephone 400 may be used as a sensor 104 to detect a discharge of a firearm. The telephone 400 may include a telephone located in a public location or in a private location within the building. For example, the telephone 400 may include a speaker phone or desk phone used by employees in their office, cubicle, or other work areas.

The microphone 402 may include a microphone used by the telephone for voice communications during telephone calls or other sound recording or transmission functions. In one embodiment, the microphone may include a microphone in a handset and/or a microphone used for speaker phone conversations. Other sensors in addition to the microphone 402 may be included in some embodiments. For example, the telephone may include a plurality of sensors 104 including any of the sensor types discussed herein.

The detection component 302 may be configured to perform any of the functions as described in relation to the detection component 302 of the gunshot detection system 102 of FIG. 3. For example, the detection component 302 located within the telephone 400 may allow analysis of sensor data (audio data from microphone 402) and detection of a gunshot to be performed at each telephone 400. Although the detection component 302 is shown as part of a telephone, the detection component 302 may be included as part of any sensor 104 without limitation. In one embodiment, the telephone 400 reports that a gunshot has been detected in response to the detection component 302 detecting the gunshot.

In one embodiment, the detection component 302 is configured to process audio in real-time in order to determine if a discharge has occurred. The detection component 302 may process sensor data from the telephone 400 (such as audio data from microphone 402) independently of sensor data of other telephones or sensors 104 to determine whether a discharge has occurred. In one embodiment, a plurality of different telephones 400 independently processes their own sensor data. In one embodiment, after receiving an indication that a discharge was detected by another sensor or telephone, the telephone 400 may reprocess the sensor data (e.g., sensor data stored by the buffer component 304) to reevaluate whether a discharge has occurred. For example, the detection component 302 may process the sensor data with a lower confidence requirement to determine whether the discharge was detected at the telephone 400. In one embodiment, the detection component 302 may classify a detected signature as a gunshot based on a likelihood that the signature corresponds to a gunshot. For example, when the signature more closely matches one or more requirements for qualifying as a gunshot signature, the detection component 302 may provide a higher confidence level than if the signature less closely matches. In one embodiment, in order to independently detect a discharge the detection component 302 must reach a higher confidence level than if one or more other devices have detected the discharge.

The buffer component 304 may be configured to perform any of the functions as described in relation to the buffer component 304 of the gunshot detection system 102 of FIG. 3. For example, the buffer component 304 located within the telephone 400 may allow for storage and buffering of sensor data (such as audio data from microphone 402) at each telephone 400. Although the buffer component 304 is shown as part of a telephone, the buffer component 304 may be included as part of any sensor 104 without limitation. In one embodiment, the telephone 400 provides sensor data stored by the buffer component 304 in response to the detection component 302 detecting the gunshot. In one embodiment, the telephone 400 provides sensor data stored by the buffer component 304 in response to receiving an indication from another sensor 104 (such as another telephone 400) or from the gunshot detection system 102 indicating that another sensor 104 had detected a discharge of a firearm within the same building.

The digital signal processor 404 includes a processor for analyzing sensor data to locate signatures indicating the occurrence of a discharge of a firearm. For example, the digital signal processor 404 may include a specialized processor for processing sensor data (such as audio data from the microphone 402, or from any other type of sensor 104) in real-time to detect audio signatures, optical signatures, chemical fume signatures, pressure signatures, or any other type of signature indicating the occurrence of a firearm discharge.

The privacy component 406 is configured to protect the privacy of one or more individuals located proximally to the telephone 400. In one embodiment, the privacy component 406 limits the storage of sensor data and/or filters sensor data to reduce privacy concerns for those near the telephone 400. For example, the privacy component 406 may be configured to protect privacy when the telephone 400 is located in a private location, such as an office. In one embodiment, if the telephone 400 is located in a public location the privacy component 406 may or may not take steps to reduce potential privacy concerns.

In one embodiment, the privacy component 406 filters out some audio data from audio data gathered by the microphone 402 for privacy. In one embodiment, the privacy component filters out all audio information above a specified frequency. For example, gunshot detection may be performed based on low frequency audio that is not audible to humans. In one embodiment, only the low frequency content is stored by the buffer component 304 and/or transmitted to a central server, such as the gunshot detection system 102. In one embodiment, the privacy component filters out vocal frequencies obtained from the microphone. For example, frequencies that are produced during speaking may be filtered out of the audio data so that human voices or conversations are not recorded. In one embodiment, the privacy component 406 allows the detection component 302 to have access to the full range of audio frequencies acquired by the microphone 402 but will only allow filtered data to be forwarded on to another location, such as the gunshot detection system 102.

In one embodiment, the privacy component 406 allows detection of a firearm discharge based on audio from the microphone if the privacy component 406 determines that an authorized user is not present. For example, the privacy component 406 may be configured to detect whether a user is logged into a computer in the same office as the telephone 400, detect an identification card (such as a radio frequency identification (ID) card), identify a person using face recognition software based on a video feed, or detect a presence of a human based on motion proximal to the telephone 400. In one embodiment, if a person or authorized person is detected, the privacy component 406 disables the detection component 302, buffer component 304, and/or gathering of audio data using the microphone 402 for discharge detection or monitoring purposes.

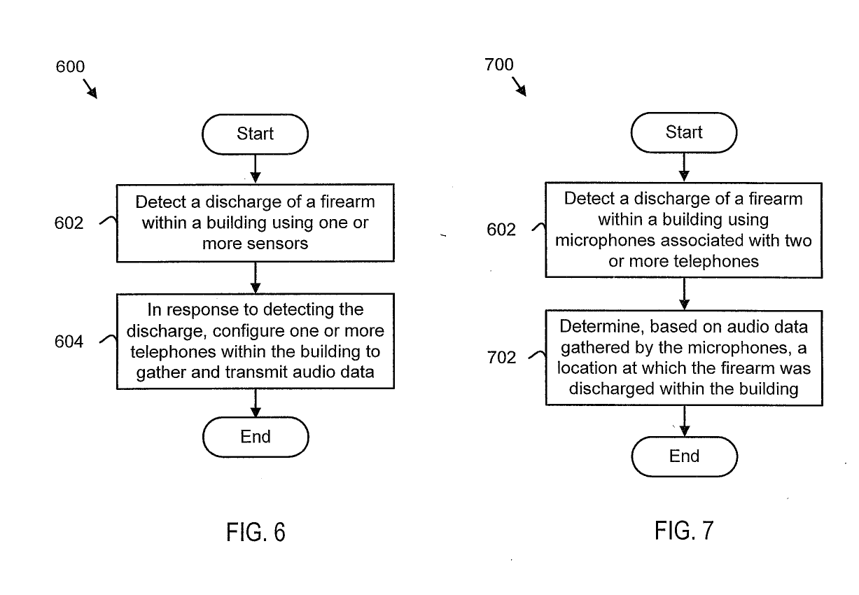

FIG. 6 is a schematic block diagram illustrating a method 600 for gunshot detection within a building. The method 600 may be implemented by the gunshot detection system 102, a telephone 400, and/or one or more sensors 104.

The method 600 begins and the detection component 302 detects 602 a discharge of a firearm within a building using one or more sensors 104. The sensors 104 may be distributed through the building such that the sensor data varies between sensors. The detection component 302 may detect 602 the discharge based on a microphone, an optical detector, a chemical detector, a pressure sensor or another sensor. For example, the detection component 302 may detect an audio signature in an audio feed from a microphone that corresponds to a discharge of a firearm. The detection component 302 may detect 602 the discharge with regard to any of the variations discussed above in relation to the gunshot detection system 102 and/or the detection component 302.

The appropriation component 308 configures 604 one or more telephones in the building to gather and transmit audio data. For example, the appropriation component 308 may configure 604 the telephones to provide audio data gathered by microphones of the telephones to allow monitoring of events within the building. The appropriation component 308 may configure the telephones to provide the audio data to a central server. The central server may include a gunshot detection system 102 that may be used to monitor events and/or monitor a location of events occurring in the building. For example, the central server may determine a location the gunshot and/or additional events occurring within the building.

FIG. 7 is a schematic block diagram illustrating a method 700 for gunshot detection within a building. The method 700 may be implemented by the gunshot detection system 102, a telephone 400, and/or one or more sensors 104.

The method 700 begins and the detection component 302 detects 602 a discharge of a firearm within a building using one or more sensors 104. For example, the detection component 302 may detect 602 the discharge with any of the variations discussed above in relation to the gunshot detection system 102 and/or the detection component 302.

The location component 306 determines 702 a location within the building where the firearm was discharged. The location component 306 may determine 702 the location based on audio data or any other type of sensor data. In one embodiment, the location component 306 determines 702 the location based on relative timing between detections of the discharge, sensor signatures gathered by the one or more sensors, or the like. In one embodiment, the location component 306 determines 702 the location with a corresponding confidence level. For example, the location component 306 may determine a likelihood as a percent chance that the gunshot occurred at a specific location.

The methods 600, 700 of FIGS. 6 and 7 are given by way of example only. For example, the methods 600, 700 may further include a buffer component 304 buffering sensor data, a countermeasure component 310 initiating one or more countermeasures, a notification component 312 providing one or more notifications of a detected discharge, an identification component 314 identifying the firearm type, and/or a variety of other functions. In one embodiment, either of the methods 600, 700 may include any of the teaching or variations discussed above in relation to the gunshot detection system 102 and/or the telephone 400.

This disclosure has been made with reference to various example embodiments. However, those skilled in the art will recognize that changes and modifications may be made to the embodiments without departing from the scope of the present disclosure. For example, various operations, as well as components for carrying out operations, may be implemented in alternate ways depending upon the particular application or in consideration of any number of cost functions associated with the operation of the system, e.g., one or more of the operations may be deleted, modified, or combined with other operations.

Additionally, as will be appreciated by one of ordinary skill in the art, principles of the present disclosure may be reflected in a computer program product on a computer-readable storage medium having computer-readable program code means embodied in the storage medium. Any tangible, non-transitory computer-readable storage medium may be utilized, including magnetic storage devices (hard disks, floppy disks, and the like), optical storage devices (CD-ROMs, DVDs, Blu-Ray discs, and the like), flash memory, and/or the like. These computer program instructions may be loaded onto a general purpose computer, special purpose computer, or other programmable data processing apparatus to produce a machine, such that the instructions that execute on the computer or other programmable data processing apparatus create a means for implementing the functions specified. These computer program instructions may also be stored in a computer-readable memory that can direct a computer or other programmable data processing apparatus to function in a particular manner, such that the instructions stored in the computer-readable memory produce an article of manufacture, including implementing means that implement the function specified. The computer program instructions may also be loaded onto a computer or other programmable data processing apparatus to cause a series of operational steps to be performed on the computer or other programmable apparatus to produce a computer-implemented process, such that the instructions that execute on the computer or other programmable apparatus provide steps for implementing the functions specified.

Many modifications of structure, arrangements, proportions, elements, materials, and components, which are particularly adapted for a specific environment and operating requirements, may be used without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. As used herein, the terms “comprises,” “comprising,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A computer readable storage medium comprising program code for causing one or more processors to perform a method, the method comprising:
detecting a discharge of a firearm within a building using one or more sensors communicatively coupled with a central server; and
in response to detecting the discharge of the firearm, configuring one or more telephones within the building to gather and transmit audio data to the central server.

2. The computer readable storage medium of claim 1, wherein the one or more sensors comprise a microphone.

3. The computer readable storage medium of claim 2, wherein detecting the discharge comprises detecting an acoustic signature of the discharge using the microphone.

4. The computer readable storage medium of claim 3, wherein detecting the acoustic signature of the discharge comprises detecting a high intensity sound with a fast rise time.

5. The computer readable storage medium of claim 3, wherein detecting the acoustic signature comprises detecting an acoustic signature based on a low frequency audio feed from the microphone, wherein audio in higher frequencies is filtered out of the low frequency audio feed.

6. The computer readable storage medium of claim 3, wherein detecting the acoustic signature comprises detecting an acoustic signature based on a non-vocal frequency feed from the microphone, wherein audio in vocal frequencies is filtered out of the low frequency audio feed.

7. The computer readable storage medium of claim 2, wherein the one or more sensors further comprise a digital signal processor to analyze audio data from the microphone.

8. The computer readable storage medium of claim 1, wherein the one or more sensors comprise an optical sensor.

9-99. (canceled)

100. A system for detecting a discharge of a firearm, the system comprising:
a detection component configured to detect a discharge of a firearm within a building using one or more sensors communicatively coupled with a central server; and
an appropriation component configured to, in response to detecting the discharge of the firearm, configure one or more telephones within the building to gather and transmit audio data to the central server.

101. The system of claim 100, wherein the one or more sensors comprise a microphone.

102. The system of claim 101, wherein the detection component detects the discharge by detecting an acoustic signature of the discharge using the microphone.

103. The system of claim 102, wherein the detection component detects the discharge by detecting a high intensity sound with a fast rise time.

104. The system of claim 102, wherein the detection component detects the discharge by detecting an acoustic signature based on a low frequency audio feed from the microphone, wherein audio in higher frequencies is filtered out of the low frequency audio feed.

105. The system of claim 102, wherein the detection component detects the discharge by detecting an acoustic signature based on a non-vocal frequency feed from the microphone, wherein audio in vocal frequencies is filtered out of the audio feed.

106. The system of claim 101, wherein the one or more sensors comprise a digital signal processor to analyze audio data from the microphone.

107. The system of claim 100, wherein the one or more sensors comprise an optical sensor.

108-119. (canceled)

120. The system of claim 100, wherein the one or more sensors comprise a plurality of sensors mounted in a plurality of rooms within the building.

121. The system of claim 100, wherein the detection component is further configured to receive sensor feeds from the one or more sensors, wherein the detection component detects the discharge based on the sensor feeds.

122. The system of claim 100, wherein the detection component detects the discharge based on receiving an indication from the one or more sensors that the discharge has been detected.

123. The system of claim 122, wherein the detection component is further configured to receive sensor data corresponding to the discharge, and wherein the detection component is further configured to confirm, at the central server, that the discharge occurred based on the received sensor data.

124. The system of claim 100, wherein the appropriation component configures the one or more telephones to gather audio data by configuring the telephones to gather the audio data using a corresponding microphone.

125. The system of claim 100, wherein the detection component detects the discharge using a sensor of the one or more telephones to detect the discharge.

126. The system of claim 125, wherein the appropriation component configures the one or more telephones to gather audio data by configuring at least the one or more telephones used to detect the discharge to gather the audio data.

127. The system of claim 126, wherein the one or more telephones used to detect the discharge comprise telephones located in one or more public areas of the building.

128. The system of claim 126, where the appropriation component configures the one or more telephones by configuring at least one telephone not used to detect the discharge to gather and transmit the audio data.

129-155. (canceled)

156. The system of claim 100, further comprising a countermeasure component configured to control lights within the building in response to the detection component detecting the discharge of the firearm.

157-169. (canceled)

170. The system of claim 100, wherein the one or more sensors comprise a plurality of sensors disparately located within the building.

171-187. (canceled)

188. The system of claim 100, wherein the appropriation component further configures the one or more telephones to transmit a time stamp.

189. The system of claim 100, wherein the appropriation component further configures the one or more telephones to transmit a location stamp.

190. The system of claim 100, wherein the appropriation component further configures the one or more telephones to transmit calibration data indicating a sensitivity of a microphone.

191-197. (canceled)

198. A method for detecting a discharge of a firearm, the method comprising:
detecting a discharge of a firearm within a building using one or more sensors communicatively coupled with a central server; and
in response to detecting the discharge of the firearm, configuring one or more telephones within the building to gather and transmit audio data to the central server.
